(19) United States
(12) Patent Application Publication
(10) Pub. No.: US 2003/0226617 A1
(43) Pub. Date: Dec. 11, 2003

(54) FLARED BUTT REDUCER FOR LOGS (II)

(76) Inventor: Andre Choquette, Quebec (CA)

Correspondence Address: David J. French, Box 2486, Stn. D, Ottawa, K1P 5W6, CA

(21) Appl. No.: 10/166,027

(22) Filed: Jun. 11, 2002

(51) Int. Cl. B26B 1/00; B26D 1/00; B27C 7/00; B27L 1/00

(52) U.S. Cl. 144/4; 83/698.41; 144/208.8

(57) ABSTRACT

A butt reducer machine is provided to remove excess wood from the swelled butt ends of logs. Cutting heads supported on pivoting arms, carried in turn within a rotating frame, are caused to oscillate circumferentially about the portion of the log to be removed. This butt-removal process may be carried out while a log is in motion longitudinally, either before or after the log enters a de-barking machine. The process may also be effected on a stationary log.

### FIELD OF THE INVENTION

This invention relates to the sawmill industry. More particularly in relates to a machine for removing the outer portion of wood present on the logs near the base or “butt” end of a log. Such machine is suited for use in sawmills and plywood mills where logs are being processed into lumber or plywood blocks. More particularly, it is suited for use in conjunction with a debarking machine.

### BACKGROUND TO THE INVENTION

In the sawmill industry logs are processed, after debarking, by running them through sawing stands that remove wood from the logs to produce squared cants and boards. As logs are rarely of a uniform diameter along their entire length, initial portions of the log must be removed from where the log is widest. Most trees have an enlarged diameter at their base, giving rise to logs with swelled butt ends. Partial slabs remove from such swelled butt ends are a nuisance to manage in a sawmill. They are not large enough to be converted into lumber, and they are difficult to convey to chippers for disposal. Consequently, one method of dealing with the logs having swelled butt ends is to buck the logs, cutting transversely across the log to remove the swelled butt end. Unfortunately, this is a costly the procedure as it removes a portion of the log, wasting good wood that could be turned into lumber.

A design for an existing machine for removing root swellings from timber logs is disclosed in U.S. Pat. No. 4,363,342 issued in 1982 to Bruks Mekaniska of Sweden. According to the design of this machine a log is rotated while a fixed-position cylindrical milling cutter is used to remove the excess wood present in the swelled butt. This procedure has the disadvantage that the log must be rotated. Rotation of the log is inconvenient because of the large mass of the log, and additionally, logs are rarely perfectly straight and cylindrically even. Therefore the positioning of the rotating log with respect to the milling head is less precise than would be preferred.

Existing reducers like the Swedish “Bruks” machine have the disadvantage that they operate “off-line”. Logs need to be taken out of the processing line, reduced and re-introduced in the line. They also involve a slow process that requires the log to be rotated against an axially fixed rotating milling head. These procedures also involves the cost of an additional operator.

A few years ago Valon Kone (a Finnish manufacturer) experimented with modifying a ring debarker to incorporate cutting plates that would remove wood in conjunction with the operation of normal debarker scraper plates that remove bark. However, due to limitations on the structure of the debarker ring, it was not possible to rotate the ring fast enough to produce a satisfactory result.

One other manufacturer on the Canadian west coast has experimented with a fixed diameter chuck head carrying cutting knives mounted to effect an encircling action around a log. While this configuration was able to remove wood from the butt end of logs, its operation was not fully satisfactory due to the fixed diameter system used to process logs.

This unit was suited for only a very narrow range of log diameters. In addition, it's compact design did not allow for the removed debris to fly-off, causing the head to “pack-up” within a short time, requiring frequent stoppages for cleaning.

An improved mechanism for removing wood from the swelled butt-end of a log would be highly desirable. This invention addresses such an objective.

The invention in its general form will first be described, and then its implementation in terms of specific embodiments will be detailed with reference to the drawings following hereafter. These embodiments are intended to demonstrate the principle of the invention, and the manner of its implementation. The invention in its broadest and more specific forms will then be further described, and defined, in each of the individual claims which conclude this Specification.

### SUMMARY OF THE INVENTION

It is a feature of the invention that the butt end of a flared log may be shaped to remove flared portions by exposing the butt end to a cutting action arising from cutting heads that rotate about the log. This shaping can be effected in a preferred embodiment through use of rotating cutting heads that may be moved inwardly and outwardly with respect to the log while such cutting heads are being rotated about the log.

According to the invention in one aspect, a log with a swelled butt end to be milled is passed axially through the central region of a rotatable frame. The log may be advanced through sequential positions whereat the log remains stationary while milling heads pass over the outer surface of the log portion that is being milled. Alternately and preferably, the log may be advanced axially through the rotatable frame while the rotatable frame is oscillating or rotating, causing the milling heads carried within the rotating frame to be passed over the outer surface of the log along circular or spiral paths. In this latter case, it is necessary for the rotatable frame to have a sufficient degree of angular freedom and speed of angular rotation to ensure that, taking into account the rate of advancement of the log, all portions of the outer surface of the log constituting the swelled butt end will be subject to milling by the milling heads.

The machine according to the invention operates on the basis of powered rotating cutting-edges carried by at least one, and preferably multiple milling heads that are, in turn, mounted within the rotating frame through displaceable cutting head supports. Each milling head is preferably mounted at and embraced by the ends of a pair of pivoting arms. The pivoting arms, as a preferred cutting head support, are supported for rotation about pivoting arm axes that are carried by the rotating frame.

The pivoting arms for the respective heads are preferably linked to allow them to move in a ganged array, advancing the milling heads generally radially towards and away from the central region of the rotating frame. The milling heads do not necessarily move precisely along radii extending outwardly from the central axis of the rotating frame. Rather they swing in arcs into the central region of the rotating frame.

Each pivoting arm has a bell-cranked protruding arm portion and an associated linking strut that extends to a further protruding portion of the next adjacent pivoting arm. Such further protruding portion is on the side of each pivoting arm axis opposite from the end of the pivoting arm that carries a milling head. Collectively, the struts extending between the pivoting arms form a closed circle. One of the struts is expandable longitudinally and lockable in its position, allowing any slackness and backlash present in the circular linkage to be eliminated.

In order to position the milling heads within the rotatable frame, one or more linear actuators in the form of an air or hydraulic cylinder, or similar mechanism, extends from a fixed position on the rotatable frame to a special extended portion associated with one of the pairs of pivoting arms. Expansion or contraction of this linear actuator means causes all of the pivoting arms to rotate about their respective pivoting axis, advancing the milling heads into the interior region of the rotatable frame, or allowing such milling heads to be withdrawn from such interior region. In this manner, logs and swelled butts of differing diameters may be accommodated.

The rotating frame is carried within an exterior stationary frame that provides bearings upon which the rotating frame may rotate. Rotation in the preferred design is not continuous but only partial. Full cutting operation is achieved by oscillating the rotatable frame.

Based on the presence of 4 milling heads, the rotating frame must be free to rotate through at least 90 degrees of angular rotation within the stationary frame in order to provide full circumferential coverage of the outside surface of a log. This is sufficient angular rotation for the rotating frame to permit at least one milling head to bear against every portion of the outside surface of a log that is held in a fixed position during the milling operation.

In cases where the log is being passed through the central region of the rotating frame in a state of continuous motion, the rotating frame preferably is free to rotate through more than the minimum angular degree needed to process the outside surface of the stationary log. It is preferable, based on four milling heads, to provide freedom for the rotating frame to rotate through 135 degrees of rotation. This allows for 22½ degrees of motion for the milling heads within which they may accelerate, decelerate, and reverse their direction of rotation. Based on the presence of three milling heads, the rotating frame must be free to rotate through at least 120 degrees, more preferably 185 degrees, of angular rotation. With two milling heads, at least 180 degrees of angular rotation must be available in order to process a stationary log.

The milling heads must be powered to enable them to effect their cutting action. Preferably, this is achieved by means of individual electrical motors mounted at the respective axis for each of the pivoting arms. A suitable linkage between each motor and its respective milling head may be effected through use of a belt drive, or equivalent.

A primary positioning means is required to rotate and reciprocate the rotating frame. Preferably this is achieved by mounting a servo motor to the outer stationary frame. This servo motor is connected to the rotating frame through belts, gears, chain or the like.

Power for the electric motors and fluid for the actuating cylinder present in the rotating frame are provided by cables and a hose that are laid down within a groove formed around the outer circumferential edge of the rotating frame. As the degree of angular rotation for this rotating frame is limited, the cable and hose is fed from a folding cable tray that pays-out and receives the linking cable and hose.

The machine according to the invention has a particular advantage in that it allows the process of removing wood from the swelled butt end of a log to be carried out “on-line”, with the log in continuous axial motion as it progresses towards or, preferably, away from a de-barking machine. The butt reducer machine of the invention includes the feature that it will adjust to the diameter of the log to be reduced. And in removing wood from the outer circumferential surface of the log, longitudinally over the span of the flared butt end, it will provide a smooth surface finish on the log, allowing wany boards of improved finish to be removed from the log.

Preferably, this butt reducer is to be located immediately after a ring debarker. Advantageously, the log support and advancement mechanism of the debarker machine may be relied upon to hold the log while the butt portion of the log is being advanced through the butt-removal station. In some cases, it may be necessary to slowdown the debarker from it's normal speed of 300-400 fpm to 100-120 fpm while the butt removal process is being carried out. This may extend the processing time for the log in the debarker machinery by 2 to 3 seconds. However, this is still a considerable improvement over the prior art alternative of removing the swelled butt portion of the log off-line.

In this manner, a useful machine may be provided which is particularly suited to shaping the flared butt-end portions of logs, rendering the logs more nearly cylindrical before the logs are passed through subsequent stations were they are reduced to cants and/or boards.

The foregoing summarizes the principal features of the invention and some of its optional aspects. The invention may be further understood by the description of the preferred embodiments, in conjunction with the drawings, which now follow.

### BRIEF DESCRIPTION OF THE DRAWINGS

FIG. 1 is a pictorial view of a butt removal station incorporating the machine of the invention as a log approaches longitudinally to be passed therethrough.

FIG. 2 is a side view of the station of FIG. 1 showing log infeed and outfeed means.

FIG. 2A is a face view of the stationary and rotating frames of the butt remover, with four pivoting arms carrying milling heads installed therein poised to commence cutting.

FIGS. 2B and 2C are the view of FIG. 2A showing respectively advancement of the cutting heads to engage a log and the positioning of the milling heads upon completion of the milling action.

FIG. 3 is a pictorial view of the pivoting arms and milling heads of the preferred 4-head variant of the invention as in FIG. 1 with their associated linkages, shown separately from the frames in which they are mounted.

FIG. 4 is a pictorial view of the stationary and rotating frames that carry the pivoting arms and milling heads, without such arms and milling heads being present.

FIG. 5 is a modified version of the reducer of FIGS. 1 and 3, showing three pivoting arms carrying three milling heads, actuated by separate hydraulic or air cylinders.

FIG. 6 is a modified version of the reducer of FIGS. 1 and 3, showing linkages between two pivoting arms carrying two milling heads.

FIG. 7 is an exit-side cut-away pictorial view through the apparatus of FIGS. 1 and 3 showing details of the mounting of the pivot arms, and motors in the rotating frame for driving the milling heads.

### DESCRIPTION OF THE PREFERRED EMBODIMENT

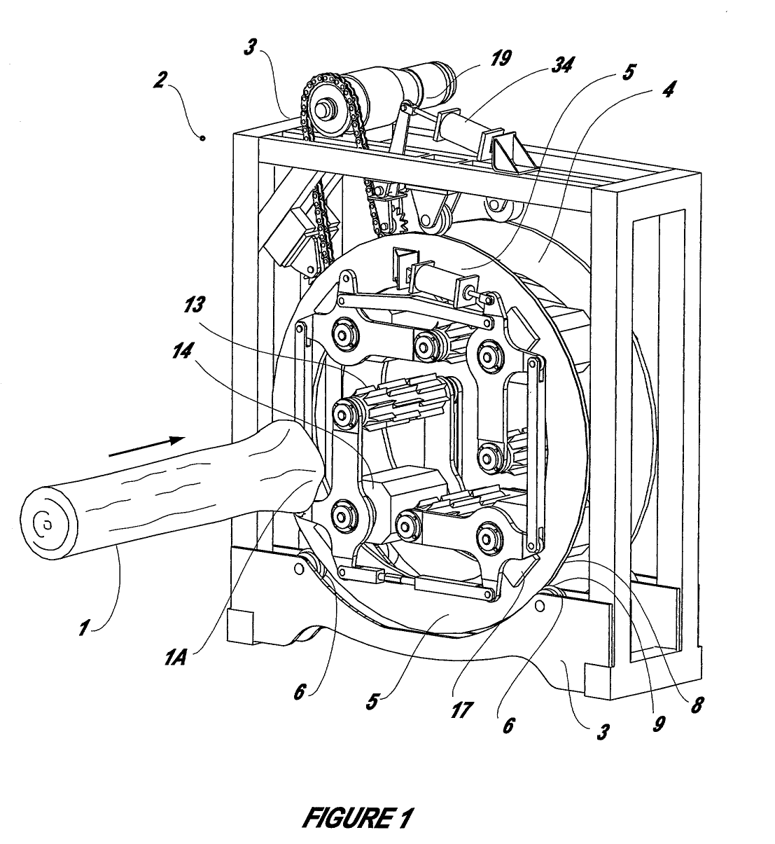

In FIG. 1 a log 1 approaches a butt-reducer station 2 according to the invention having an outer fixed frame 3 and an inner rotating frame 4. The rotating frame 4 consists of two disc-shaped plates 5 supported on roller bearings 6. The plates 5 are joined by bars 7 that cause them to rotate in unison on the bearings 6.

One of the plates 5 is grooved around its circumferential edge 8. One of the bearings 6 has a circular flange 9 that interfits into the grooved edge 8 to stabilize the pair of plates laterally. The other bearing 6 has a smooth face on its circumferential surface.

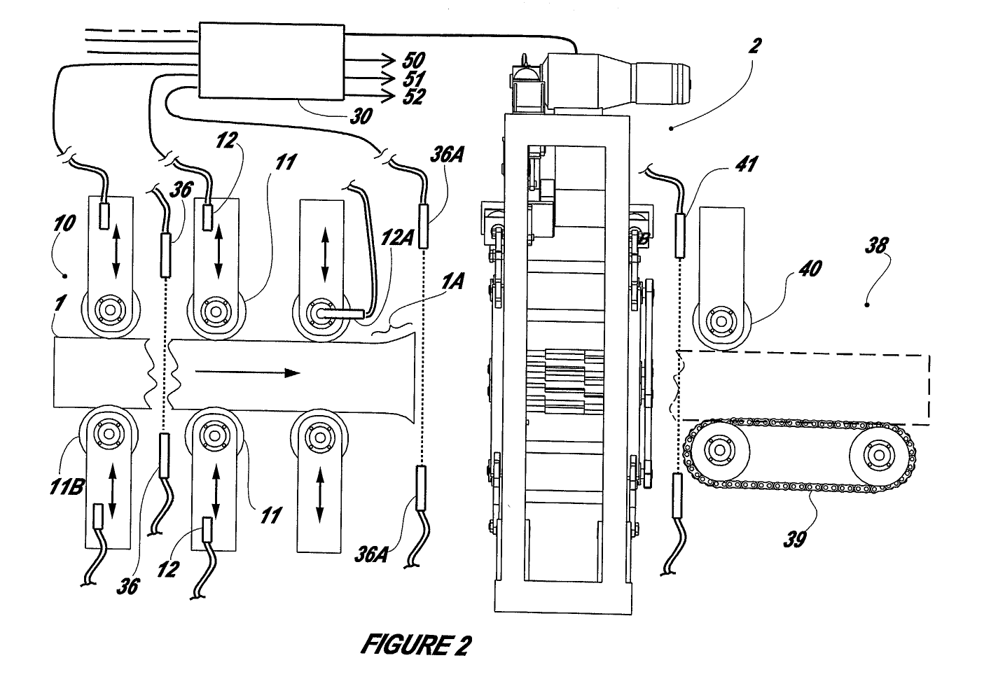

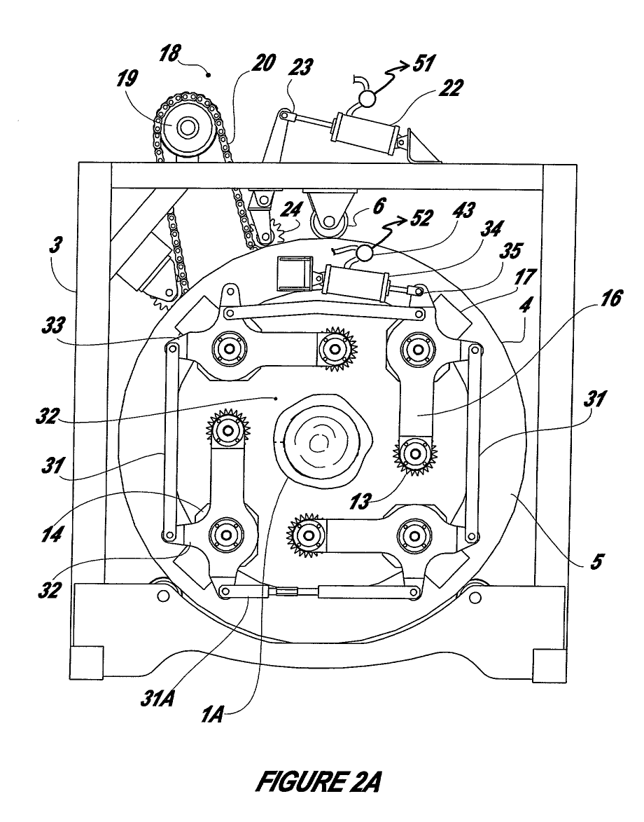

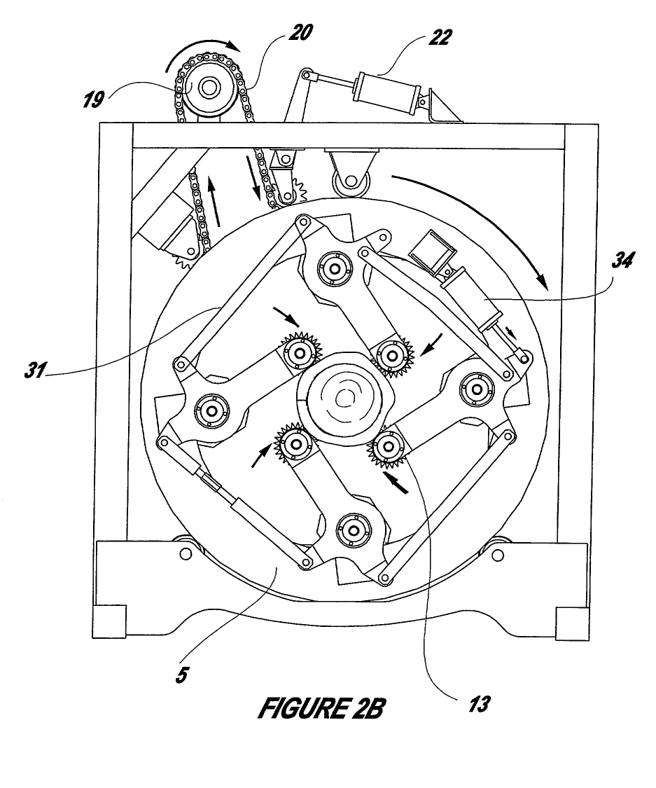

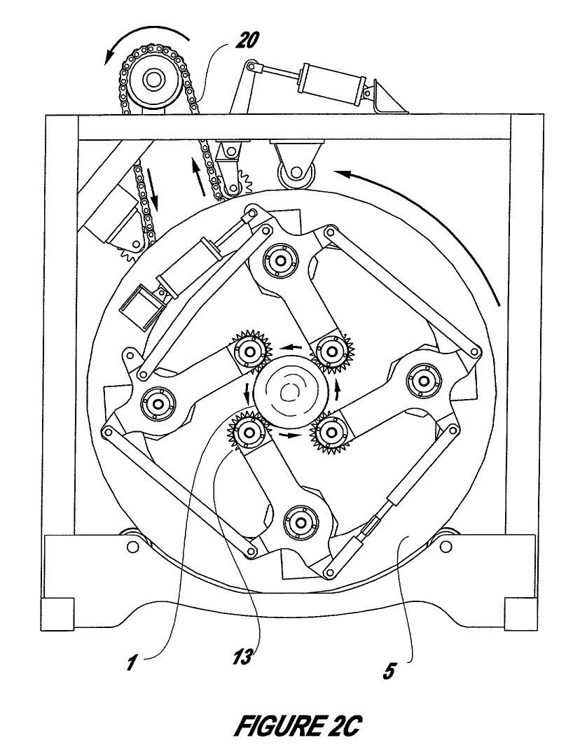

Logs 1 are fed into the butt-reducer station 2 as shown in FIG. 2 by an infeed system 10. The log infeed system 10 may comprise paired rollers 11 that are slideably mounted and actuated in response to a feedback control system using sensors 12 to maintain the central alignment of the log 1. A further sensor 12A on a roller detects the speed of advancement of the log 1. Alternately, two path-interrupting sensors 36, 36A may be used to determine log speed. In some cases log debarker machines rely upon such a roller-based log support system. The two roller pairs 11A closest to the reducer station 2 could be the exit rollers from a debarker.

On the other side of a debarker, further roller pairs 11B also provide support for the log 1. By whatever means the logs 1 are supported, the infeed system 10 feeds the logs 1 axially into the butt reducer station 10.

The roller pair 11 having sensors 12 will adjust to the diameter of the butt-end 1A of a log 1 as it passes-by spreading apart to accommodate its passage. This displacement may be sensed and used as a measure of the width of the butt-end of the log as this width may be required to control the butt-cutting process to follow. This same roller pair sensing arrangement may also detect the diameter of the main portion of the log 1, which dimension is used by the controller 30 to control the cutting process in the reducer station 2.

As shown in FIG. 2A, the rotating frame 4 supports a linked assembly of rotatable cutting heads 13. These milling head 13, which may be about 30 inches long in their axial length, are powered by motors 14 through belts 15 or equivalent linkages.

Each milling head 13 is mounted on and embraced by a pair of pivoting arms 16. These arms 16, together with milling head actuators 34 constitute actuatable displaceable milling head supports. The pivoting arms 16 are carried about pivoting axes 46 that are supported by the rotating frame 4 through support plates 17 welded to the disc-shaped plates 5 at spaced intervals.

The pivoting arms 16 for the respective heads 13 are preferably linked by linkage bars 31 to allow them to move in a ganged array, advancing the milling heads 13 generally radially towards and away from the central region 32 of the rotating frame 4.

Each pivoting arm 16 has a bell-cranked protruding arm portion 32 and an associated linking strut 31 that extends to a further protruding portion 33 of the next adjacent pivoting arm 16. Such further protruding portion 33 is on the side of each pivoting arm axis opposite from the end of the pivoting arm 16 that carries a milling head 13. Collectively, the struts 31 extending between the pivoting arms 16 form a closed circle. One of the struts 31A is expandable longitudinally and lockable in its position, allowing any slackness and backlash present in the circular linkage to be eliminated.

In order to position the milling heads 13 within the rotatable frame 4, one or more mill head linear actuators 34 in the form of an air or hydraulic cylinder, or similar mechanism, extends from a fixed position on the rotatable frame 4 to a special extended portion 35 associated with one of the pairs of pivoting arms 16. Expansion or contraction of this linear mill head actuator means 35 causes all of the pivoting arms to rotate about their respective pivoting axes 46, advancing the milling heads 13 into the interior region 32 of the rotatable frame 4, or allowing such milling heads 13 to be withdrawn from such interior region 32. In this manner, logs 1 and swelled butts 1A of differing diameters may be accommodated.

The control system for the butt-reducer station 2 in the preferred mode of operation detects the arrival of a log 1 through path-interrupting sensors 36, 36A, and waits until about 6 inches of the butt-end 1A of the log 1 has entered between the milling heads 13. At this point, the mill head actuator 34 is caused by the controller 30 to rotate the pivot arms 16, advancing the milling heads 13 towards the butt-end 1A.

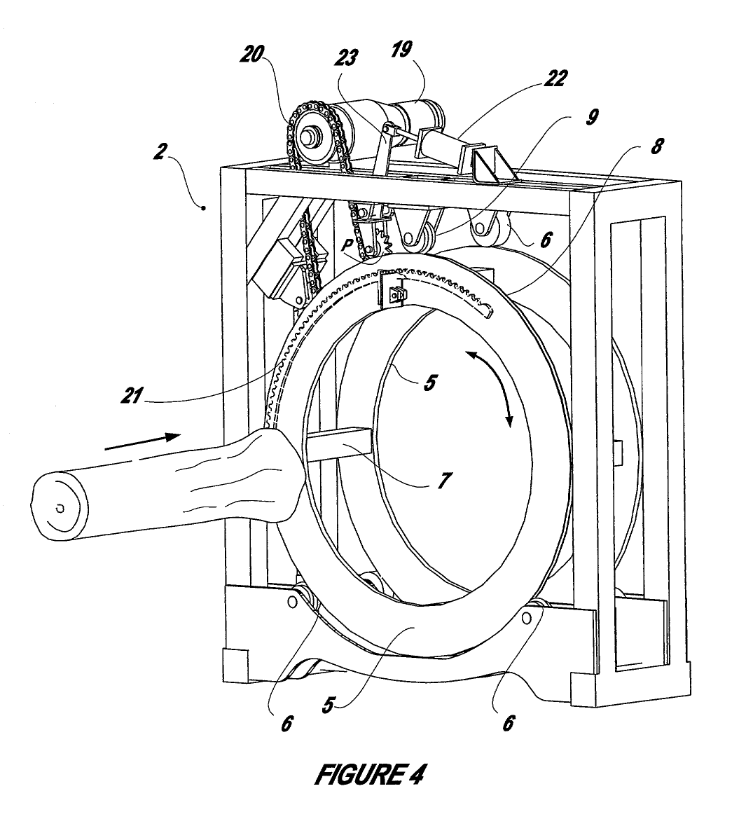

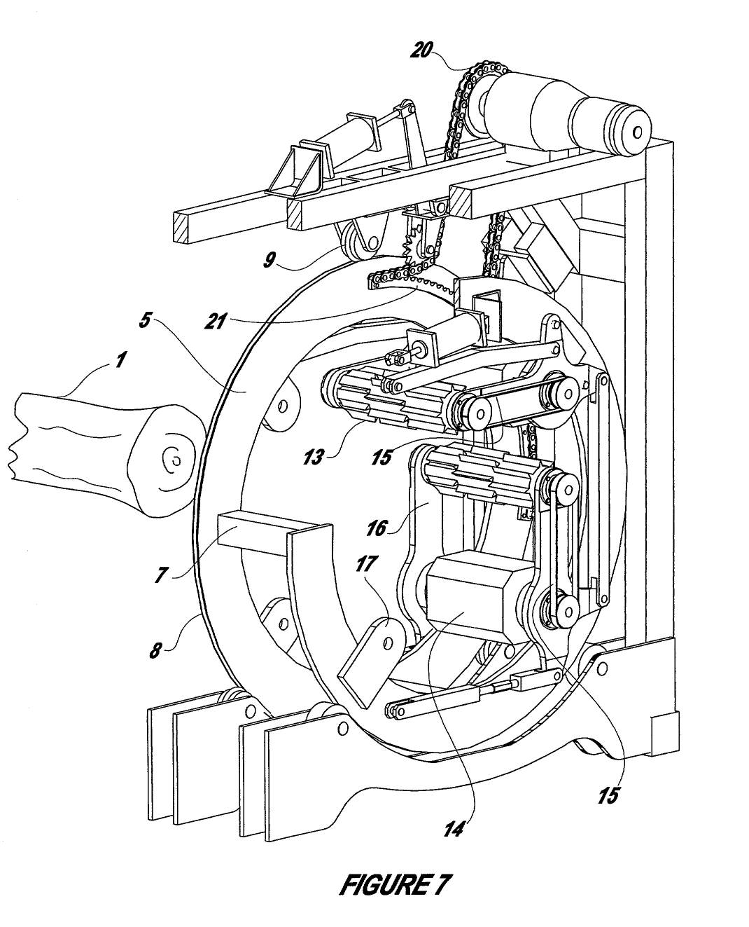

Simultaneously, a frame positioning system 18 causes the rotating frame 4 to rotate. The frame positioning system 18 may operate on the basis of a positioning or stepping servo-motor 19 mounted on the fixed frame 3 to drive a chain 20 that engages a cogged track 21 on one of the circular plates 5 of the rotating frame 4—see FIGS. 4 and 7. By this means, rotation of the positioning motor 19 will correspondingly rotate and position the rotatable frame 4.

To maintain tension in the chain 20 a linear actuator 22 preferably in the form of an air or hydraulic cylinder 22 mounted to the fixed frame 3 causes, through linkages 23, a sprogged wheel 24 to take up any slack in the chain 20.

The frame positioning system 18 in the preferred embodiment with four milling heads 13 causes the rotating frame 4 to oscillate through a range of about 135 degrees while the milling heads 13 engage the butt-end 1A of the log 1. During this reciprocating displacement of the rotating frame 4, the milling head positioning actuator(s) 34 cause the milling heads 13 to advance into the butt-end 1A of the log 1, removing unwanted wood. This combined reciprocating action of the rotatable frame 3 and inward displacement of the milling heads 13 is shown sequentially in FIGS. 2A, 2B and 2C.

While the cutting action on the butt-end 1A is occurring, the log 1 in the preferred variant is advancing. As the log 1 is being presented with its butt-end 1A in advance of the log 1, and as the cutting action only commences once the butt-end 1A is between the milling heads 13, the advancement of the log does not interfere with the cutting action. Cutting and rotation of the frame 4 under guidance from a controller 30 occurs at such a rate as to ensure that the diameter of the butt-end 1A is reduced to the main diameter of the log 1 before the butt-end 1A has passed beyond the milling heads 13.

While a range of rotation of 90 degrees would be sufficient to reduce the butt-end 1A of a stationary log 1 using four milling heads 13, a preferred range of 135 degrees allows time for the rotating frame 4 to accelerate and reverse while still ensuring that the entire circumferential span of the butt-end 1A of a normal log 1 is reduced. Oscillation may also be effected within the ranges of 120-150 degrees. In special cases where the butt-end 1A is of a particularly extended length, it may be necessary for an operator or the control system to reduce the speed of the log 1 as it passes through the reducing station 2.

As log 1 passes through the reducing station 2, it is received as it exits the machine by a log outfeed system 38. As shown in FIG. 1B this may optionally be based on a traditional chain carrier having a chain 39 that supports the log 1. One or more hold-down rollers 40 may be positioned above the log 1 to stabilize the log 1 on the chain 39. Sensor 41 detects both the arrival of a log 1 at the outfeed conveyor, and its final passage past the sensor 41.

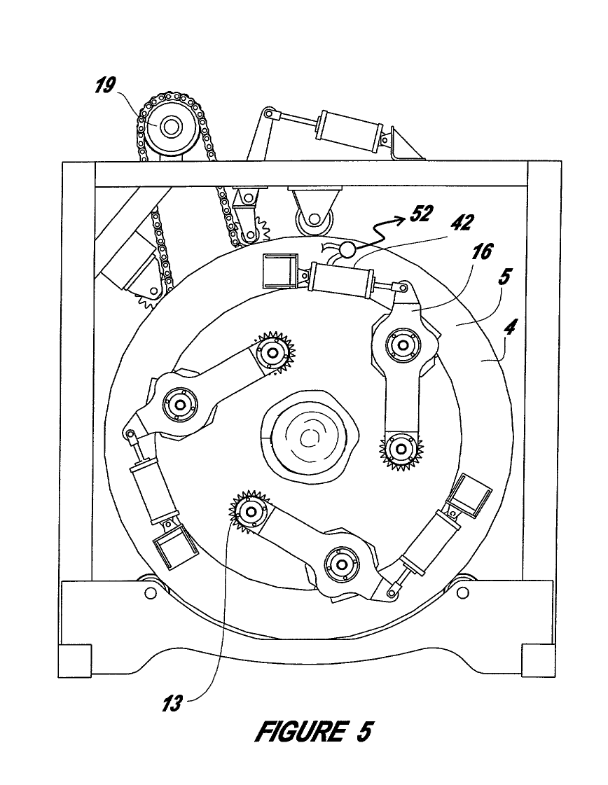

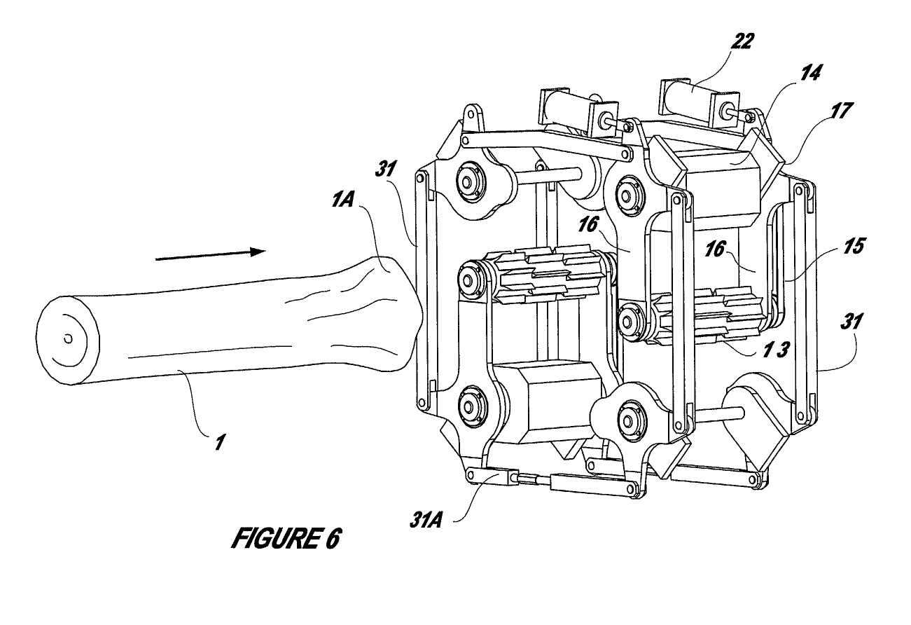

While the preferred embodiment of the system relies upon the use of four milling heads 13, the system of the invention may operate with three, two and even only one milling head 13. Systems with three and two milling heads are shown in FIGS. 5 and 6 respectively. These systems have the advantage of a symmetrical layout that results in balanced loads, etc.

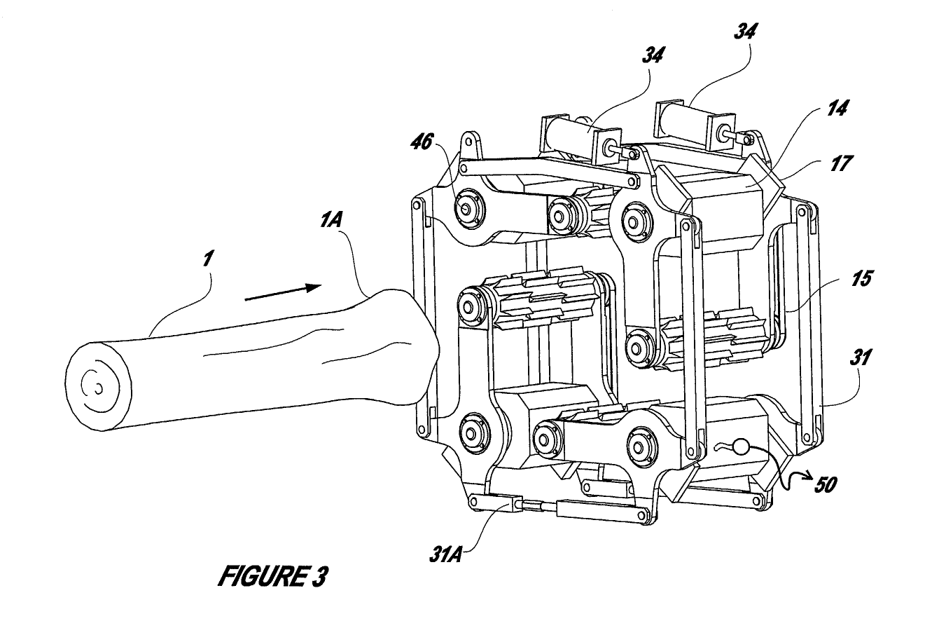

In FIG. 5 the linkages 31 between the pivoting arms 16 of FIG. 3 have been replaced by three pivot arm linear actuators 42 which separately control the positioning of each pivoting arm 16. Each pivot-arm linear actuator 42 is anchored at one end to a plate 5 of the rotating frame 4 and connected at its other end to a pivot arm 16. Actuators 42 act in synchronization with the positioning of the rotating frame 4, which is also subject to control by the controller 30 through the controller's actuation of the positioning motor 19. This same synchronized action is effected in case of the FIG. 3 and FIG. 6 configurations wherein the controller 30 provides commands 51, 52, 53 to the milling head actuators 34 through servo-valve 43, and other system elements.

FIGS. 5 and 6 depict preferred symmetrically balanced milling head configurations. A single milling head system would not enjoy the benefits of being symmetrically balanced. However, a butt-reducer station 2 with a single head could still operate on the basis of the invention, albeit with reduced efficiency.

Conclusion

The foregoing has constituted a description of specific embodiments showing how the invention may be applied and put into use. These embodiments are only exemplary. The invention in its broadest, and more specific aspects, is further described and defined in the claims which now follow.

These claims, and the language used therein, are to be understood in terms of the variants of the invention which have been described. They are not to be restricted to such variants, but are to be read as covering the full scope of the invention as is implicit within the invention and the disclosure that has been provided herein.

The embodiments of the invention in which an exclusive property or privilege is claimed are defined as follows:

1. A flared-butt reducer machine for removing the enlarged portion of a log at its butt-end comprising:
(a) an outer stationary frame;
(b) a rotatable frame carried by the stationary frame and actuated by rotatable frame positioning means for rotation within the stationary frame, said rotatable frame having a central region for receiving the passage of a log with a swelled butt-end;
(c) at least one powered cutting head carried by the rotatable frame through an actuated, displaceable cutting head support that permits advancement of the cutting head towards the central region of the rotatable frame;
(d) a controller for coordinating the rotation of the rotatable frame with the displacement of the cutting head into the central region of the rotatable frame,
whereby, when a log with a swelled butt-end is passed into the central region of the rotatable frame, the cutting head is caused to advance, and the rotatable frame is rotated in response to the controller, to effect removal of the swelled portion of the butt-end of the log.

2. A reducer machine as in claim 1 comprising a plurality of symmetrically deployed cutting heads carried by a plurality of actuated displaceable cutting head supports.

3. A reducer machine as in claim 2 consisting of four cutting heads and four actuated displaceable cutting head supports.

4. A reducer as in claim 3 wherein the cutting head supports respectively comprise pivoting arms with respective pivoting arm axes for each cutting head, said pivoting arms being linked by linkages to form a ganged array whereby all cutting heads will advance into the interior region of the rotating frame in unison under control of the controller.

5. A reducer as in claim 2 wherein the cutting head supports respectively comprise pivoting arms with respective pivoting arm axes for each cutting head, and further comprising respective actuation means each coupled to each of the pivot arms, said respective actuation means being seated on the rotatable frame and being positioned to advance the cutting heads in unison into the interior region of the rotatable frame under control of the controller.

6. A reducer as in claim 3 wherein the cutting head supports respectively comprise pivoting arms with respective pivoting arm axes for each cutting head, and further comprising respective actuation means each coupled to each of the pivot arms, said respective actuation means being seated on the rotatable frame and being positioned to advance the cutting heads in unison into the interior region of the rotatable frame under control of the controller.

7. A reducer as in claim 4 comprising respective actuation means each coupled to each of the pivot arms, said respective actuation means being seated on the rotatable frame and being positioned to advance the cutting heads in unison into the interior region of the rotatable frame under control of the controller.

8. A reducer as in claim 3 wherein the rotating frame is mounted for oscillation through a range of 120 to 150 degrees.

9. A reducer as in claim 4 wherein the rotating frame is mounted for oscillation through a range of 120 to 150 degrees.

10. A reducer as in claim 6 wherein the rotating frame is mounted for oscillation through a range of 120 to 150 degrees.

11. A reducer as in claim 6 wherein the rotating frame is mounted for oscillation through a range of 120 to 150 degrees.

12. A reducer machine as in claim 8 wherein the rotating frame is mounted for oscillation through a range of substantially 135 degrees.

13. A reducer machine as in claim 9 wherein the rotating frame is mounted for oscillation through a range of substantially 135 degrees.

14. A reducer machine as in claim 10 wherein the rotating frame is mounted for oscillation through a range of substantially 135 degrees.

15. A reducer as in claim 11 wherein the rotating frame is mounted for oscillation through a range of substantially 135 degrees.

16. A reducer machine as in claim 1 in combination with a log feed that advances a log continuously through the central region of the rotatable frame while the swelled portion of the butt-end of a log is being removed.

17. A reducer machine as in claim 2 in combination with a log feed that advances a log continuously through the central region of the rotatable frame while the swelled portion of the butt-end of a log is being removed.

18. A reducer machine as in claim 3 in combination with a log feed that advances a log continuously through the central region of the rotatable frame while the swelled portion of the butt-end of a log is being removed.

19. A reducer machine as in claim 4 in combination with a log feed that advances a log continuously through the central region of the rotatable frame while the swelled portion of the butt-end of a log is being removed.

20. A reducer machine as in claim 5 in combination with a log feed that advances a log continuously through the central region of the rotatable frame while the swelled portion of the butt-end of a log is being removed.
